(19) United States
(12) Patent Application Publication
(10) Pub. No.: US 2025/0284543 A1
(43) Pub. Date: Sep. 11, 2025

(54) MUTUAL EXCLUSION DEVICE, MUTUALLY EXCLUSIVE ACCESS METHOD AND SYSTEM FOR SHARED RESOURCE, AND HOST

(71) Applicant: Beijing ESWIN Computing Technology Co., Ltd., Beijing City (CN)

(72) Inventor: Guohua Chen, Beijing City (CN)

(73) Assignee: Beijing ESWIN Computing Technology Co., Ltd., Beijing City (CN)

(21) Appl. No.: 18/962,765

(22) Filed: Nov. 27, 2024

(30) Foreign Application Priority Data
Mar. 7, 2024 (CN) 202410263715X

(51) Int. Cl. G06F 9/50

(52) U.S. Cl. CPC G06F 9/5027

(57) ABSTRACT

The present application provides a mutual exclusion (mutex) device, a mutually exclusive access method and system for a shared resource, and a host. The method is performed by a target host, where the target host is any host among multiple hosts, and the multiple hosts are connected to the mutex device and the shared resource through a bus. The mutex device includes a mutex status register and a mutex set register; the mutex set register includes multiple first fields, the multiple first fields are in one-to-one correspondence with the multiple hosts, and each first field is used for identifying a request status of the multiple hosts for a mutex. The mutex status register includes multiple second fields, the multiple second fields are in one-to-one correspondence with the multiple hosts and each second field is used for identifying a hold status of the multiple hosts for the mutex. The method includes: setting a first field corresponding to the target host in the mutex set register to a first value in case of a determination that the target host has transmitted a mutex request; and setting a second field corresponding to the target host in the mutex status register to a second value and accessing the shared resource in case of a determination that the target host has successfully requested the mutex. In the method, by means of the register group in the mutex device, multiple hosts are identified by the mutex set register and the mutex status register respectively and the shared resource may be simply and effectively accessed without relying on strong algorithms and at low costs, which has strong universality

### FIELD

The present application relates to the field of resource access, and in particular to a mutual exclusion device, a mutually exclusive access method and system for a shared resource, and a host.

### BACKGROUND

Mutual exclusion (mutex) is used to prevent two or more objects from accessing a shared resource simultaneously in multi-object control. The object may be a host or a thread.

In a traditional system on a chip (SoC), there are often different types of objects, such as central processing unit (CPU), digital signal processor (DSP) and other hosts. The mutex is of strong demand when the shared resource between the objects needs to be exclusively accessed.

During access to the shared resource, there are many ways to implement mutex, which may be a pure software method, a combination of software and hardware, or a pure hardware method. However, the pure software method relies on a powerful algorithm, and both the combination of software and hardware, and a pure hardware method are costly and lack universality.

### BRIEF SUMMARY

The present application provides a mutual exclusion (mutex) device, a mutually exclusive access method and system for a shared resource, and a host, which are used to solve defects that traditional methods for access to a shared resource rely on strong algorithms, are costly and lack universality. By using a register group in the mutex device, multiple hosts are identified by a mutex set register and a mutex status register respectively and the shared resource may be simply and effectively accessed without relying on strong algorithms and at low costs, which has strong universality.

The present application provides a mutual exclusion (mutex) device, including a register group, where the register group is connected to a shared resource and multiple hosts through a bus; the register group includes a mutex set register and a mutex status register, the mutex set register includes multiple first fields, the multiple first fields are in one-to-one correspondence with the multiple hosts; the mutex status register includes multiple second fields, the multiple second fields are in one-to-one correspondence with the multiple hosts;
the mutex set register is used for identifying a request status of the multiple hosts for a mutex, where a first field corresponding to a host that has transmitted a mutex request is set to a first value; and
the mutex status register is used for identifying a hold status of the multiple hosts for the mutex, where a second field corresponding to a host that successfully requests the mutex is set to a second value, and the second value is used for indicating that the host that successfully requests the mutex accesses the shared resource.

According to the mutex device provided by the present application, the register group further includes a mutex clear register; the mutex clear register includes multiple third fields, the multiple third fields are in one-to-one correspondence with the multiple hosts; where the mutex clear register is used for identifying a clear status of the multiple hosts for the mutex, where the third field corresponding to the host that successfully clears the mutex is set to a third value.

The present application provides a mutually exclusive access method for a shared resource, performed by a target host, where the target host is any host among multiple hosts, and the multiple hosts are connected to a mutual exclusion (mutex) device and a shared resource through a bus. The mutex device includes a mutex status register and a mutex set register. The mutex set register includes multiple first fields, the multiple first fields are in one-to-one correspondence with the multiple hosts, and each first field is used for identifying a request status of the multiple hosts for a mutex. The mutex status register includes multiple second fields, the multiple second fields are in one-to-one correspondence with the multiple hosts and each second field is used for identifying a hold status of the multiple hosts for the mutex. The method includes:
setting a first field corresponding to the target host in the mutex set register to a first value in case of a determination that the target host has transmitted a mutex request; and
setting a second field corresponding to the target host in the mutex status register to a second value and accessing the shared resource in case of a determination that the target host has successfully requested the mutex.

According to the mutually exclusive access method for the shared resource provided by the present application, the register group further includes a mutex clear register; the mutex clear register includes multiple third fields, the multiple third fields are in one-to-one correspondence with the multiple hosts, and each third field is used for identifying a clear status of the multiple hosts for the mutex, and the method further includes: setting a third field corresponding to the target host in the mutex clear register to a third value in case of a determination that the target host has successfully cleared the mutex.

According to the mutually exclusive access method for the shared resource provided by the present application, the method further includes: continuously requesting the mutex until the target host successfully requests the mutex in case of a determination that the target host does not successfully request the mutex.

According to the mutually exclusive access method for the shared resource provided by the present application, the method further includes: continuously clearing the mutex until the target host successfully clears the mutex in case of a determination that the target host does not successfully clear the mutex.

The present application further provides a target host, where the target host is any host among multiple hosts, and the multiple hosts are connected to a mutual exclusion (mutex) device and a shared resource through a bus. The mutex device includes a mutex status register and a mutex set register. The mutex set register includes multiple first fields, the multiple first fields are in one-to-one correspondence with the multiple hosts, and each first field is used for identifying a request status of the multiple hosts for a mutex. The mutex status register includes multiple second fields, the multiple second fields are in one-to-one correspondence with the multiple hosts and each second field is used for identifying a hold status of the multiple hosts for the mutex. The target host includes:
a first processing circuit, used for setting a first field corresponding to the target host in the mutex set register to a first value in case of a determination that the target host has transmitted a mutex request; and
a second processing circuit, used for setting a second field corresponding to the target host in the mutex status register to a second value and accessing the shared resource in case of a determination that the target host has successfully requested the mutex.

The present application further provides a mutually exclusive access system for a shared resource, including multiple hosts, a mutual exclusion (mutex) device and a shared resource, where the multiple hosts are connected to the mutex device and the shared resource through a bus; the mutex device includes a mutex status register and a mutex set register; the mutex set register includes multiple first fields, the multiple first fields are in one-to-one correspondence with the multiple hosts, and each first field is used for identifying a request status of the multiple hosts for a mutex; the mutex status register includes multiple second fields, the multiple second fields are in one-to-one correspondence with the multiple hosts and each second field is used for identifying a hold status of the multiple hosts for the mutex. The multiple hosts implement the mutually exclusive access method for the shared resource as described above when executing a program.

The present application further provides an electronic device, including a memory, a processor, and a computer program stored in the memory and executable in the processor, and the processor implements the mutually exclusive access method for the shared resource as described above when executing the program.

The present application further provides a non-transitory computer-readable storage medium storing a computer program, where the computer program, when executed by a processor, implements the mutually exclusive access method for the shared resource as described above.

The present application further provides a computer product storing a computer program, where the computer program, when executed by a processor, implements the mutually exclusive access method for the shared resource as described above.

In the mutex device, the mutually exclusive access method and system for the shared resource, and the host provided by the present application, the method is performed by a target host, where the target host is any host among the multiple hosts, and the multiple hosts are connected to a mutual exclusion (mutex) device and a shared resource through a bus. The mutex device includes a mutex status register and a mutex set register; the mutex set register includes multiple first fields, the multiple first fields are in one-to-one correspondence with the multiple hosts, and each first field is used for identifying a request status of the multiple hosts for a mutex. The mutex status register includes multiple second fields, the multiple second fields are in one-to-one correspondence with the multiple hosts and each second field is used for identifying a hold status of the multiple hosts for the mutex. The method includes: setting a first field corresponding to the target host in the mutex set register to a first value in case of a determination that the target host has transmitted a mutex request; and setting a second field corresponding to the target host in the mutex status register to a second value and accessing the shared resource in case of a determination that the target host has successfully requested the mutex. In the method, by means of the register group in the mutex device, multiple hosts are identified by the mutex set register and the mutex status register respectively, and the shared resource may be simply and effectively accessed without relying on strong algorithms and at low costs, which has strong universality.

### BRIEF DESCRIPTION OF THE DRAWINGS

In order to illustrate the solutions in the embodiments of the present application or in the related art more clearly, the drawings used in the description of the embodiments or the related art are briefly described below. The drawings in the following description are only some embodiments of the present application, and other drawings may be obtained according to these drawings without any creative work for those skilled in the art.

FIG. 1 is a schematic structural diagram of a mutual exclusion (mutex) device according to the present application;

FIG. 2 is a schematic structural diagram of a register group according to the present application;

FIG. 3 is a schematic flowchart of a mutually exclusive access method for a shared resource according to the present application;

FIG. 4a is a schematic flowchart of requesting a mutex according to the present application;

FIG. 4b is a schematic flowchart of clearing a mutex according to the present application;

FIG. 5a is a first schematic structural diagram of a target host according to the present application;

FIG. 5b is a second schematic structural diagram of a target host according to the present application;

FIG. 6 is a schematic structural diagram of a mutually exclusive access system for a shared resource according to the present application; and

FIG. 7 is a schematic structural diagram of an electronic device according to the present application.

### DETAILED DESCRIPTION

In order to illustrate the objects, solutions and advantages of the application, the solutions in present the application will be described clearly and completely below in combination with the drawings in the application. The described embodiments are part of the embodiments of the application, not all of them. All other embodiments obtained by a person of ordinary skill in the art based on the embodiments of the present application without any creative work belong to the scope of the present application.

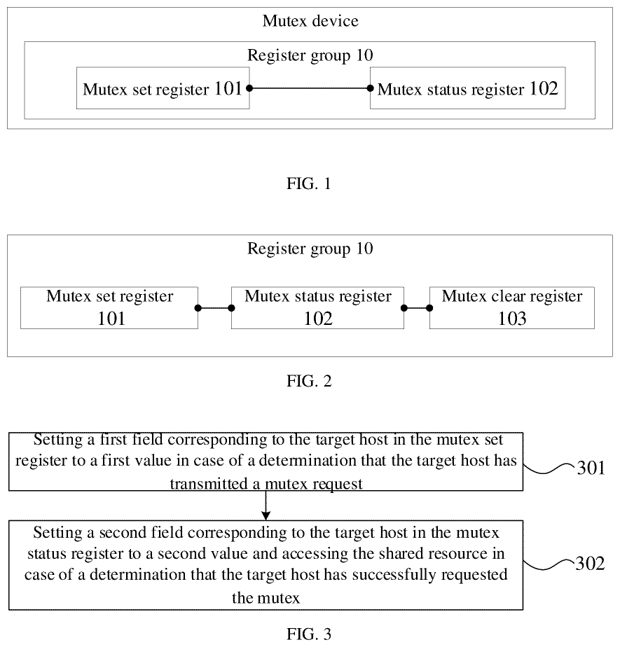

FIG. 1 is a schematic structural diagram of a mutual exclusion (mutex) device according to the present application. The mutex device may include a register group 10, where the register group 10 is connected to a shared resource and multiple hosts through a bus. The register group 10 may include a mutex set register 101 and a mutex status register 102. The mutex set register 101 may include multiple first fields, the multiple first fields are in one-to-one correspondence with the multiple hosts. The mutex status register 102 may include multiple second fields, the multiple second fields are in one-to-one correspondence with the multiple hosts; where
the mutex set register 101 is used for identifying a request status of the multiple hosts for a mutex, where a first field corresponding to a host that has transmitted a mutex request is set to a first value; and
the mutex status register 102 is used for identifying a hold status of the multiple hosts for the mutex, where a second field corresponding to a host that successfully requests the mutex is set to a second value, and the second value is used for indicating that the host that successfully requests the mutex accesses the shared resource.

In an embodiment, the mutex device is a bus slave interface. In an embodiment, the bus slave interface may be various buses such as an advanced extensible interface (AXI), an advanced high-performance bus (AHB), and an advanced peripheral bus (APB). A user may make choices based on actual needs.

The mutex set register 101 is a write-only register and cannot be read. The multiple first fields (i.e., first register (clr) bits) in mutex set register 101 are usually composed of one or more binary bits. In case that the shared resource is not accessed, the mutex device must be in an idle state, that is, the values of multiple first fields in mutex set register 101 are all set to 0. In case that the target host accesses the shared resource, the target host first transmits a mutex request to the mutex device. In case that it is detected that the target host has transmitted the mutex request, the first value of the first field corresponding to the target host in mutex set register 101 is set to 1. Simultaneously, first values of the first fields corresponding to other hosts in mutex set register 101 are still 0 and remains unchanged.

The target host is any host among the multiple hosts.

The mutex status register 102 is a read-only register and cannot be written. The multiple second fields (i.e., second register bits) in mutex status register 102 are usually composed of one or more binary bits. A value of the second field corresponding to the target host in the mutex status register 102 may be a one-hot code when this value is non-zero since the mutex device may only be held by one host.

The host usually refers to a central processing unit (CPU) in computer hardware and a memory (such as a memory bank) in a service system, which are responsible for processing instructions and data.

The shared resource is a resource that may be used by multiple objects. The access to the shared resource requires a chip with exclusive access control, which means that the access to the shared resource is exclusive. That is, when one of the multiple hosts has accessed the shared resource, other hosts cannot access the shared resource.

In an embodiment, the request for the mutex is considered invalid in case that the values of multiple first fields in the mutex set register 101 are all 1.

FIG. 2 is a structural schematic diagram of the register group according to the present application. The register group 10 may further include a mutex clear register 103. The mutex clear register 103 may include multiple third fields, the multiple third fields are in one-to-one correspondence with the multiple hosts; where the mutex clear register 103 is used for identifying a clear status of the multiple hosts for the mutex, where the third field corresponding to the host that successfully clears the mutex is set to a third value.

In an embodiment, the mutex clear register 103 is a write-only register and cannot be read. The multiple third fields in mutex clear register 103 are usually composed of one or more binary bits. In case that the target host clears the mutex, only the host holds the mutex, that is, the second value of the second field corresponding to the target host in the mutex status register 102 is set to 1, and at this time, the third value of the third field corresponding to the host in the mutex clear register 103 is also be set to 1.

In an embodiment, the clear for the mutex is considered invalid in case that the values of multiple third fields in the mutex clear register 103 are all 1.

The embodiment of the present application is further described below by taking the target host as an example.

The target host is any host among the multiple hosts, and the multiple hosts are connected to the mutex device and the shared resource through a bus. The mutex device includes a mutex status register and a mutex set register. The mutex set register includes multiple first fields, the multiple first fields are in one-to-one correspondence with the multiple hosts, and each first field is used for identifying a request status of the multiple hosts for a mutex. The mutex status register includes multiple second fields, the multiple second fields are in one-to-one correspondence with the multiple hosts and each second field is used for identifying a hold status of the multiple hosts for the mutex.

FIG. 3 is a schematic flowchart of a mutually exclusive access method for a shared resource according to the present application. The method may include:
301: setting a first field corresponding to the target host in the mutex set register to a first value in case of a determination that the target host has transmitted a mutex request; and
302: setting a second field corresponding to the target host in the mutex status register to a second value and accessing the shared resource in case of a determination that the target host has successfully requested the mutex.

In some embodiments, the register group further includes a mutex clear register; the mutex clear register includes multiple third fields, the multiple third fields are in one-to-one correspondence with the multiple hosts, and each third field is used for identifying a clear status of the multiple hosts for the mutex, and the method may further include: setting a third field corresponding to the target host in the mutex clear register to a third value in case of a determination that the target host has successfully cleared the mutex.

In some embodiments, the method may further include: continuously requesting the mutex until the target host successfully requests the mutex in case of a determination that the target host does not successfully request the mutex.

In case of a determination that the target host does not successfully request the mutex, the second field corresponding to the target active may be continuously read in the mutex status register to determine whether the second field is set to the second value until it is determined that the second field is set to the second value, indicating that the target host successfully requests the mutex.

In some embodiments, the method may further include: continuously clearing the mutex until the target host successfully clears the mutex in case of a determination that the target host does not successfully clear the mutex.

In case of a determination that the target host does not successfully clear the mutex, the third field corresponding to the target active may be continuously read in the mutex clear register to determine whether the second field is set to the third value until it is determined that the third field is set to the third value, indicating that the target host successfully clears the mutex.

In an embodiment, the target host uses the mutex set register, the mutex status register and the mutex clear register to request a mutex, clear the mutex, and query the hold status of the mutex to determine whether the target host itself controls the access control for the shared resource.

In an embodiment of the present application, the first field corresponding to the target host in the mutex set register is set to the first value in case of a determination that the target host transmits a mutex request. The second field corresponding to the target host in the mutex status register is set to the second value, and the shared resource is accessed in case of a determination that the target host successfully requests a mutex. In the method, by means of the register group in the mutex device, multiple hosts are identified by the mutex set register and the mutex status register respectively and the shared resource may be simply and effectively accessed without relying on strong algorithms and at low costs, which has strong universality.

To further understand the embodiment of the present application, the following examples are described in detail.

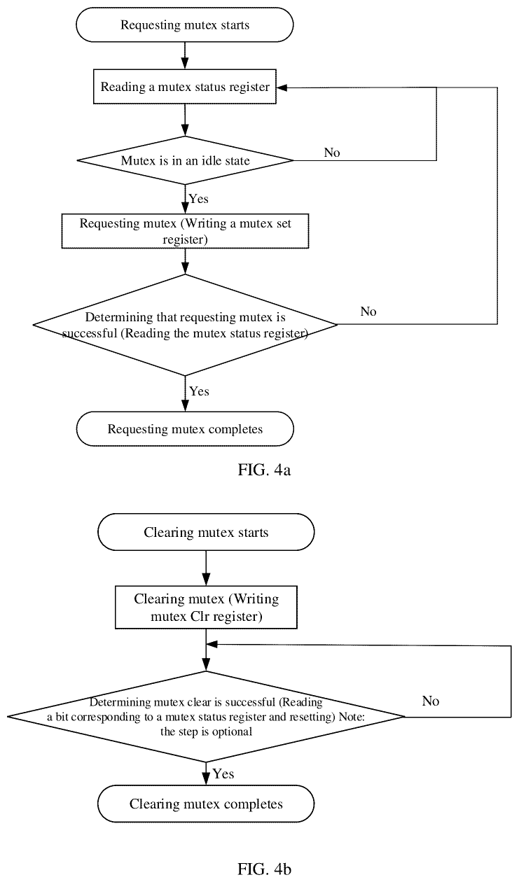

Example 1: FIG. 4a is a schematic flowchart of requesting a mutex according to the present application. As may be seen from FIG. 4a, in case of a determination that the target host has transmitted a mutex request, the first field corresponding to the target host in the mutex set register is set to the first value and the first value is used for identifying that the target host has successfully transmitted the mutex request. In case that the first field is not set to the first value, it means that the target host has not transmitted a mutex request and the target host may continuously transmit the mutex request until the mutex request is successfully transmitted. In case of a determination that the target host has successfully requested the mutex, the second field corresponding to the target host in the mutex status register is set to the second value and the second value is used for identifying that the target host has successfully requested the mutex. In case that the second field is not set to the second value, it means that the target host has not successfully requested the mutex and the target host may continuously request the mutex until the target host successfully requests the mutex.

Example 2: FIG. 4b is a schematic flowchart of clearing a mutex according to the present application. As may be seen from FIG. 4b, in case that the access to the shared resource ends, the mutex is cleared. In an embodiment, in case of a determination that the target host has successfully cleared the mutex, the third field corresponding to the target host in the mutex clear register is set to the third value, and the third value is used for identifying that the target host has successfully cleared the mutex. In case that the third field is not set to the third value, it means that the target host has not cleared the mutex and the mutex may be continuously cleared until the target host successfully cleared the mutex.

Example 3: the register group in the mutex device is described based on three hosts.

TABLE 1
Mutex set register

| Address offset | | 0x0 | | |
|---|---|---|---|---|
| bits | Field name | Attr. | Reset | Description |
| [2:0] | Set | W | 0x0 | The mutex set register includes multiple first |
| | | | | fields, and the multiple first fields are in one-to- |
| | | | | one correspondence with the multiple hosts. Each |
| | | | | first field is used for identifying the request status |
| | | | | of the corresponding host for the mutex. In case |
| | | | | that the shared resource is not accessed, the mutex |
| | | | | may be in an idle state (i.e., all the values of |
| | | | | multiple first fields in the mutex set register are set |
| | | | | to 0). In case that the target host accesses the |
| | | | | shared resource, the target host first transmits a |
| | | | | mutex request to the mutex device, and in case |
| | | | | that it is detected that the mutex request has been |
| | | | | transmitted, the first value of the first field |
| | | | | corresponding to the target host in the mutex set |
| | | | | register is set to 1. It is noted that the request for |
| | | | | the mutex is considered invalid in case that all the |
| | | | | values of multiple first fields in the mutex set |
| | | | | register are 1. In addition, the mutex set register is |
| | | | | unreadable. |

TABLE 2
Mutex clear register

| Address offset | | 0x4 | | |
|---|---|---|---|---|
| bits | Field name | Attr. | Reset | description |
| [2:0] | Clr | W | 0x0 | The mutex clear register includes multiple |
| | | | | third fields, and the multiple third fields are in |
| | | | | one-to-one correspondence with the multiple |
| | | | | hosts. Each third field is used for identifying a |
| | | | | clear status of the corresponding target host |
| | | | | for the mutex. In case that the target host has |
| | | | | successfully cleared the mutex, only the target |
| | | | | host holds the mutex (the second value of the |
| | | | | second field corresponding to the target host |
| | | | | in the mutex status register is set to 1, and the |
| | | | | third value of the third field corresponding to |
| | | | | the host in the mutex clear register is also be |
| | | | | set to 1. It is noted that the clear for the mutex |
| | | | | is considered invalid in case that all the values |
| | | | | of multiple third fields in the mutex clear |
| | | | | register are 1. In addition, the mutex clear |
| | | | | register is unreadable. |

TABLE 3
Mutex status register

| Address offset | | 0x8 | | |
|---|---|---|---|---|
| bits | Field name | Attr. | Reset | description |
| [2:0] | St | R | 0x0 | The mutex status register includes multiple |
| | | | | second fields, and the multiple second fields |
| | | | | are in one-to-one correspondence with the |
| | | | | multiple hosts. Each second field is used for |
| | | | | identifying a hold status of the corresponding |
| | | | | host for the mutex. It is noted that a value of |
| | | | | the second field corresponding to the target |
| | | | | host in the mutex status register may be a one- |
| | | | | hot code when this value is non-zero since the |
| | | | | mutex device may only be held by one host. |

Combined with Example 1, Example 2 and Example 3, in the entire process of mutually exclusive access to shared resources, by means of the register group in the mutex device, multiple hosts are identified by the mutex set register and the mutex status register respectively and the shared resource may be simply and effectively accessed without relying on strong algorithms and at low costs, which has strong universality.

The target host provided by the present application is described below and the target host described below and the mutually exclusive access method for the shared resource described above may be referenced to each other.

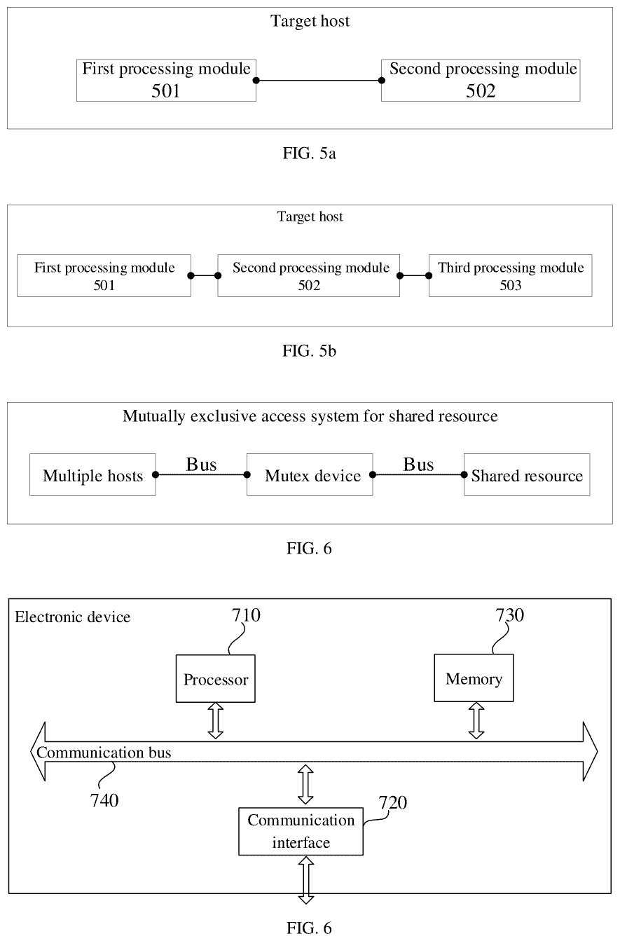

FIG. 5a is a schematic structural diagram of a target host according to the present application. The target host is any host among multiple hosts, and the multiple hosts are connected to a mutual exclusion (mutex) device and a shared resource through a bus. The mutex device includes a mutex status register and a mutex set register. The mutex set register includes multiple first fields, the multiple first fields are in one-to-one correspondence with the multiple hosts, and each first field is used for identifying a request status of the multiple hosts for a mutex. The mutex status register includes multiple second fields, the multiple second fields are in one-to-one correspondence with the multiple hosts and each second field is used for identifying a hold status of the multiple hosts for the mutex. The target host may include:
a first processing module processing module 501, used for setting a first field corresponding to the target host in the mutex set register to a first value in case of a determination that the target host has transmitted a mutex request; and
a second processing module processing module 502, used for setting a second field corresponding to the target host in the mutex status register to a second value and accessing the shared resource in case of a determination that the target host has successfully requested the mutex.

In an embodiment, the register group further includes a mutex clear register; the mutex clear register includes multiple third fields, the multiple third fields are in one-to-one correspondence with the multiple hosts, and each third field is used for identifying a clear status of the multiple hosts for the mutex. FIG. 5b is a structural schematic diagram of a target host according to the present application, the target host may further include: a third processing module processing module 503, used for setting a third field corresponding to the target host in the mutex clear register to a third value in case of a determination that the target host has successfully cleared the mutex.

In an embodiment, the second processing module processing module 502 is further used for continuously requesting the mutex until the target host successfully requests the mutex in case of a determination that the target host does not successfully request the mutex.

In an embodiment, the third processing module processing module 503 is further used for continuously clearing the mutex until the target host successfully clears the mutex in case of a determination that the target host does not successfully clear the mutex.

FIG. 6 is a schematic structural diagram of a mutually exclusive access system for a shared resource, and the system may include multiple hosts, a mutual exclusion (mutex) device and a shared resource. The multiple hosts are connected to the mutex device and the shared resource through a bus. The mutex device includes a mutex status register and a mutex set register; the mutex set register includes multiple first fields, the multiple first fields are in one-to-one correspondence with the multiple hosts, and each first field is used for identifying a request status of the multiple hosts for a mutex. The mutex status register includes multiple second fields, the multiple second fields are in one-to-one correspondence with the multiple hosts and each second field is used for identifying a hold status of the multiple hosts for the mutex. The multiple hosts implement the mutually exclusive access method for the shared resource when executing a program, and the method is performed by a target host, and the target host is any host among multiple hosts. The method includes: setting a first field corresponding to the target host in the mutex set register to a first value in case of a determination that the target host has transmitted a mutex request; and setting a second field corresponding to the target host in the mutex status register to a second value and accessing the shared resource in case of a determination that the target host has successfully requested the mutex.

In an embodiment, a standard mutex device includes three registers, namely, a mutex set register 101, a mutex status register 102 and a mutex clear register 103. The above-mentioned mutually exclusive access system may include one or more mutex devices, and has strong universality. In case that multiple mutex devices need to be extended, it is only necessary to instantiate a standard mutex device multiple times, which may not only realize the effective extension of the mutex device, but also reduce the arrangement cost of the mutex device.

The working principle of the mutex device is as follows: whether the target host itself controls the access control of the shared resource is clarified by requesting a mutex, clearing a mutex, and querying the hold status of the mutex, which results in simple and efficient whole working principle.

FIG. 7 is a structural schematic diagram of an electronic device according to the present application. The electronic device may include a processor 710, a communication interface 720, a memory 730, and a communication bus 740. The processor 710, the communication interface 720, and the memory 730 communicate with each other through the communication bus 740. The processor 710 may call logic instructions in the memory 730 to perform the mutually exclusive access method for the shared resource, and the method is performed by a target host. The target host is any host among multiple hosts, and the multiple hosts are connected to a mutual exclusion (mutex) device and a shared resource through a bus. The mutex device includes a mutex status register and a mutex set register; the mutex set register includes multiple first fields, the multiple first fields are in one-to-one correspondence with the multiple hosts, and each first field is used for identifying a request status of the multiple hosts for a mutex. The mutex status register includes multiple second fields, the multiple second fields are in one-to-one correspondence with the multiple hosts and each second field is used for identifying a hold status of the multiple hosts for the mutex. The method includes: setting a first field corresponding to the target host in the mutex set register to a first value in case of a determination that the target host has transmitted a mutex request; and setting a second field corresponding to the target host in the mutex status register to a second value and accessing the shared resource in case of a determination that the target host has successfully requested the mutex.

In addition, the logic instructions in the memory 730 described above may be implemented in the form of a software functional unit and may be stored in a computer readable storage medium while being sold or used as a separate product. Based on such understanding, the solution of the present application or a part of the solution, which is essential or contributes to the prior art, may be embodied in the form of a software product, which is stored in a storage medium, including several instructions to cause a computer device (which may be a personal computer, server, or network device, etc.) to perform all or part of the steps of the methods described in various embodiments of the present application. The storage medium described above includes various media that may store program codes such as flash disk, mobile hard disk, read-only memory (ROM), random access memory (RAM), magnetic disk, or a compact disk.

The present application further provides a computer program product, the computer program product includes a computer program, the computer program may be stored on a non-transitory computer-readable storage medium. The computer program, when executed by a processor, may perform the mutually exclusive access method for a shared resource provided by the above methods, the method is performed by a target host, the target host is any host among multiple hosts, and the multiple hosts are connected to a mutual exclusion (mutex) device and a shared resource through a bus. The mutex device includes a mutex status register and a mutex set register; the mutex set register includes multiple first fields, the multiple first fields are in one-to-one correspondence with the multiple hosts, and each first field is used for identifying a request status of the multiple hosts for a mutex. The mutex status register includes multiple second fields, the multiple second fields are in one-to-one correspondence with the multiple hosts and each second field is used for identifying a hold status of the multiple hosts for the mutex. The method includes: setting a first field corresponding to the target host in the mutex set register to a first value in case of a determination that the target host has transmitted a mutex request; and setting a second field corresponding to the target host in the mutex status register to a second value and accessing the shared resource in case of a determination that the target host has successfully requested the mutex.

The present application further provides a non-transitory computer-readable storage medium, storing a computer program, and the computer program, when executed by a processor, implements the mutually exclusive access method for the shared resource provided by the above methods, the method is performed by a target host, the target host is any host among multiple hosts, and the multiple hosts are connected to a mutual exclusion (mutex) device and a shared resource through a bus. The mutex device includes a mutex status register and a mutex set register; the mutex set register includes multiple first fields, the multiple first fields are in one-to-one correspondence with the multiple hosts, and each first field is used for identifying a request status of the multiple hosts for a mutex. The mutex status register includes multiple second fields, the multiple second fields are in one-to-one correspondence with the multiple hosts and each second field is used for identifying a hold status of the multiple hosts for the mutex. The method includes: setting a first field corresponding to the target host in the mutex set register to a first value in case of a determination that the target host has transmitted a mutex request; and setting a second field corresponding to the target host in the mutex status register to a second value and accessing the shared resource in case of a determination that the target host has successfully requested the mutex.

The device embodiments described above are merely illustrative, wherein the units described as separate components may or may not be physically separate, and the components displayed as units may or may not be physical units, that is, may be located at the same place or be distributed to multiple network units. Some or all of the modules may be selected according to actual needs to achieve the purpose of the solution of the present embodiment. Those skilled in the art may understand and implement the embodiments described above without paying creative labors.

Through the description of the embodiments above, those skilled in the art can clearly understand that the various embodiments can be implemented by means of software and a necessary general hardware platform, and of course, by hardware. Based on such understanding, the solutions of the present application in essence or a part of the solutions that contributes to the prior art, or a part of the solutions, may be embodied in the form of a software product, which may be stored in a storage medium such as ROM/RAM, magnetic discs, optical discs, etc., and includes several instructions to cause a computer device (which may be a personal computer, server, or network device, etc.) to perform the methods described in various embodiments or a part thereof.

Finally, it should be noted that the above embodiments are only used to explain the solutions of the present application, and are not limited thereto; although the present application is described in detail with reference to the foregoing embodiments, it should be understood by those skilled in the art that they can still modify the solutions described in the foregoing embodiments and make equivalent replacements to a part of the features and these modifications and substitutions do not depart from the scope of the solutions of the embodiments of the present application.

What is claimed is:

1. A mutual exclusion (mutex) device, comprising a register group, wherein the register group is connected to a shared resource and multiple hosts through a bus; the register group comprises a mutex set register and a mutex status register, the mutex set register comprises multiple first fields, the multiple first fields are in one-to-one correspondence with the multiple hosts; the mutex status register comprises multiple second fields, the multiple second fields are in one-to-one correspondence with the multiple hosts; wherein
the mutex set register is used for identifying a request status of the multiple hosts for a mutex, a first field corresponding to a host that has transmitted a mutex request is set to a first value; and
the mutex status register is used for identifying a hold status of the multiple hosts for the mutex, a second field corresponding to a host that successfully requests the mutex is set to a second value, and the second value is used for indicating that the host that successfully requests the mutex accesses the shared resource.

2. The mutex device of claim 1, further comprising a mutex clear register; wherein the mutex clear register comprises multiple third fields, the multiple third fields are in one-to-one correspondence with the multiple hosts;
the mutex clear register is used for identifying a clear status of the multiple hosts for the mutex, and the third field corresponding to the host that successfully clears the mutex is set to a third value.

3. A mutually exclusive access method for a shared resource, performed by a target host, wherein the target host is any host among multiple hosts, and the multiple hosts are connected to a mutual exclusion (mutex) device and a shared resource through a bus, the mutex device comprises a mutex status register and a mutex set register; the mutex set register comprises multiple first fields, the multiple first fields are in one-to-one correspondence with the multiple hosts, and each first field is used for identifying a request status of the multiple hosts for a mutex; the mutex status register comprises multiple second fields, the multiple second fields are in one-to-one correspondence with the multiple hosts and each second field is used for identifying a hold status of the multiple hosts for the mutex, the method comprises:
setting a first field corresponding to the target host in the mutex set register to a first value in case of a determination that the target host has transmitted a mutex request; and
setting a second field corresponding to the target host in the mutex status register to a second value and accessing the shared resource in case of a determination that the target host has successfully requested the mutex.

4. The method of claim 3, wherein the register group further comprises a mutex clear register; the mutex clear register comprises multiple third fields, the multiple third fields are in one-to-one correspondence with the multiple hosts, and each third field is used for identifying a clear status of the multiple hosts for the mutex, and the method further comprises:
setting a third field corresponding to the target host in the mutex clear register to a third value in case of a determination that the target host has successfully cleared the mutex.

5. The method of claim 3, further comprising:
continuously requesting the mutex until the target host successfully requests the mutex in case of a determination that the target host does not successfully request the mutex.

6. The method of claim 3, further comprising:
continuously clearing the mutex until the target host successfully clears the mutex in case of a determination that the target host does not successfully clear the mutex.

7. The method of claim 4, further comprising:
continuously clearing the mutex until the target host successfully clears the mutex in case of a determination that the target host does not successfully clear the mutex.

8. A mutually exclusive access system for a shared resource, comprising multiple hosts, a mutual exclusion (mutex) device and a shared resource, wherein the multiple hosts are connected to the mutex device and the shared resource through a bus; the mutex device comprises a mutex status register and a mutex set register; the mutex set register comprises multiple first fields, the multiple first fields are in one-to-one correspondence with the multiple hosts, and each first field is used for identifying a request status of the multiple hosts for a mutex; the mutex status register comprises multiple second fields, the multiple second fields are in one-to-one correspondence with the multiple hosts and each second field is used for identifying a hold status of the multiple hosts for the mutex; the multiple hosts implement a mutually exclusive access method for a shared resource of claim 3 when executing a program.

9. An electronic device comprising a memory, a processor, and a computer program stored in the memory and executable in the processor, wherein the processor, when executing the computer program, performs a mutually exclusive access method for a shared resource of claim 3.

10. The electronic device of claim 9, wherein the register group further comprises a mutex clear register; the mutex clear register comprises multiple third fields, the multiple third fields are in one-to-one correspondence with the multiple hosts, and each third field is used for identifying a clear status of the multiple hosts for the mutex, and the processor, when executing the computer program, further performs the step of:
setting a third field corresponding to the target host in the mutex clear register to a third value in case of a determination that the target host has successfully cleared the mutex.

11. The electronic device of claim 9, wherein the processor, when executing the computer program, further performs the step of:
continuously requesting the mutex until the target host successfully requests the mutex in case of a determination that the target host does not successfully request the mutex.

12. The electronic device of claim 9, wherein the processor, when executing the computer program, further performs the step of:
continuously clearing the mutex until the target host successfully clears the mutex in case of a determination that the target host does not successfully clear the mutex.

13. The electronic device of claim 10, wherein the processor, when executing the computer program, further performs the step of:
continuously clearing the mutex until the target host successfully clears the mutex in case of a determination that the target host does not successfully clear the mutex.
